(19) United States
(12) Patent Application Publication
(10) Pub. No.: US 2015/0244200 A1
(43) Pub. Date: Aug. 27, 2015

(54) METHOD FOR PERFORMING WIRELESS CHARGING CONTROL OF AN ELECTRONIC DEVICE WITH AID OF FREQUENCY DETECTION, AND ASSOCIATED APPARATUS

(71) Applicant: MEDIATEK INC., Hsin-Chu (TW)

(72) Inventors: Kuan-Kai Juan, Hsinchu County (TW); Patrick Stanley Riehl, Cambridge, MA (US); Anand Satyamoorthy, Somerville, MA (US); Yung-Chih Yen, Tainan City (TW); Yuh-Long Yeh, Taipei City (TW); Hung-Yen Chen, Taipei City (TW); Jui-Ching Yang, Taipei City (TW)

(21) Appl. No.: 14/555,663

(22) Filed: Nov. 27, 2014

Related U.S. Application Data
(60) Provisional application No. 61/944,628, filed on Feb. 26, 2014.

(51) Int. Cl. H02J 7/02; H02J 7/00

(52) U.S. Cl. CPC H02J 7/025; H02J 7/007; H02J 7/0052

(57) ABSTRACT

A method for performing wireless charging control of an electronic device and an associated apparatus are provided, where the method includes the steps of: performing at least one frequency detection operation according to at least one signal of the electronic device to generate at least one detection result; and determining a specific set of program codes within a plurality of sets of program codes to be an active set of program codes according to the aforementioned at least one detection result, and loading the specific set of program codes from a non-volatile (NV) memory of the electronic device, to control wireless charging operations of the electronic device. For example, the aforementioned at least one signal of the electronic device can be at least one induced signal of a power input coil of the electronic device or at least one derivative of the aforementioned at least one induced signal.

### CROSS REFERENCE TO RELATED APPLICATIONS

This application claims the benefit of U.S. Provisional Application No. 61/944,628, which was filed on Feb. 26, 2014, and is included herein by reference.

### BACKGROUND

The present invention relates to compatibility of a wireless power transfer system, and more particularly, to a method for performing wireless charging control of an electronic device, and an associated apparatus.

According to the related art, a conventional wireless power transfer system may comprise a conventional transmitter pad that is arranged to charge a conventional electronic device wirelessly. As various electronic products that are useful may be available on the market, the user may own a plurality of conventional electronic devices respectively corresponding to different wireless charging specifications. However, further problems such as some side effects may occur. For example, the user typically needs to prepare a plurality of conventional transmitter pads respectively corresponding to the aforementioned different wireless charging specifications, for use of wirelessly charging the plurality of conventional electronic devices, respectively, and therefore the related costs may be increased. In another example, in a situation where the user owns a plurality of conventional transmitter pads respectively corresponding to the aforementioned different wireless charging specifications, for use of wirelessly charging the plurality of conventional electronic devices, respectively, the user may feel confused since two or more conventional transmitter pads within the plurality of conventional transmitter pads may look very much alike. In another example, in a situation where the user owns a plurality of conventional transmitter pads respectively corresponding to the aforementioned different wireless charging specifications, for use of wirelessly charging the plurality of conventional electronic devices, respectively, the user may need more space for storage of the plurality of conventional transmitter pads. Thus, a novel method is required to enhance the compatibility of a wireless power transfer system.

### SUMMARY

It is an objective of the claimed invention to provide a method for performing wireless charging control of an electronic device, and an associated apparatus, in order to solve the above-mentioned problems.

It is another objective of the claimed invention to provide a method for performing wireless charging control of an electronic device, and an associated apparatus, in order to enhance the compatibility of a wireless power transfer system.

According to at least one preferred embodiment, a method for performing wireless charging control of an electronic device is provided, where the method comprises the steps of: performing at least one frequency detection operation according to at least one signal (e.g. one or more signals) of the electronic device to generate at least one detection result; and determining a specific set of program codes within a plurality of sets of program codes to be an active set of program codes according to the aforementioned at least one detection result, and loading the specific set of program codes from a non-volatile (NV) memory of the electronic device, to control wireless charging operations of the electronic device. For example, the aforementioned at least one signal of the electronic device may comprise at least one induced signal (e.g. one or more induced signals) of a power input coil of the electronic device or at least one derivative (e.g. one or more derivatives) of the aforementioned at least one induced signal, and/or at least one timing signal (e.g. one or more timing signals) of a specific stage within at least one stage (e.g. one or more stages) coupled to the power input coil mentioned above.

According to at least one preferred embodiment, an apparatus for performing wireless charging control of an electronic device is provided, where the apparatus comprises at least one portion of the electronic device. The apparatus comprises a NV memory, a frequency detection module, and a controller, where the frequency detection module is coupled to a power input coil of the electronic device, and the controller is coupled to the NV memory and the frequency detection module. More particularly, the NV memory is arranged for storing information for the electronic device. In addition, the frequency detection module is arranged for performing at least one frequency detection operation according to at least one signal (e.g. one or more signals) of the electronic device to generate at least one detection result. Additionally, the controller is arranged for determining a specific set of program codes within a plurality of sets of program codes to be an active set of program codes according to the aforementioned at least one detection result, and loading the specific set of program codes from the NV memory, to control wireless charging operations of the electronic device. For example, the aforementioned at least one signal of the electronic device may comprise at least one induced signal (e.g. one or more induced signals) of a power input coil of the electronic device or at least one derivative (e.g. one or more derivatives) of the aforementioned at least one induced signal, and/or at least one timing signal (e.g. one or more timing signals) of a specific stage within at least one stage (e.g. one or more stages) coupled to the power input coil mentioned above.

It is an advantage of the present invention that the present invention method and the associated apparatus can accurately detect the type of the transmitter pad (e.g. the specification or standard that the transmitter pad complies with), and therefore the related art problems (e.g. the problem of having to prepare a plurality of conventional transmitter pads respectively corresponding to the aforementioned different wireless charging specifications, or the problem of getting confused, or the problem of needing more space for storage of the plurality of conventional transmitter pads) can be prevented. In addition, the present invention method and the associated apparatus can enhance the compatibility of a wireless power transfer system.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an apparatus for performing wireless charging control of an electronic device according to a first embodiment of the present invention.

FIG. 2 is a diagram of a wireless power transfer system according to an embodiment of the present invention.

FIG. 3 illustrates a flowchart of a method for performing wireless charging control of an electronic device according to an embodiment of the present invention.

FIG. 4 illustrates a control scheme involved with the method shown in FIG. 3 according to an embodiment of the present invention.

FIG. 5 illustrates a control scheme involved with the method shown in FIG. 3 according to another embodiment of the present invention.

FIG. 6 illustrates a control scheme involved with the method shown in FIG. 3 according to another embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

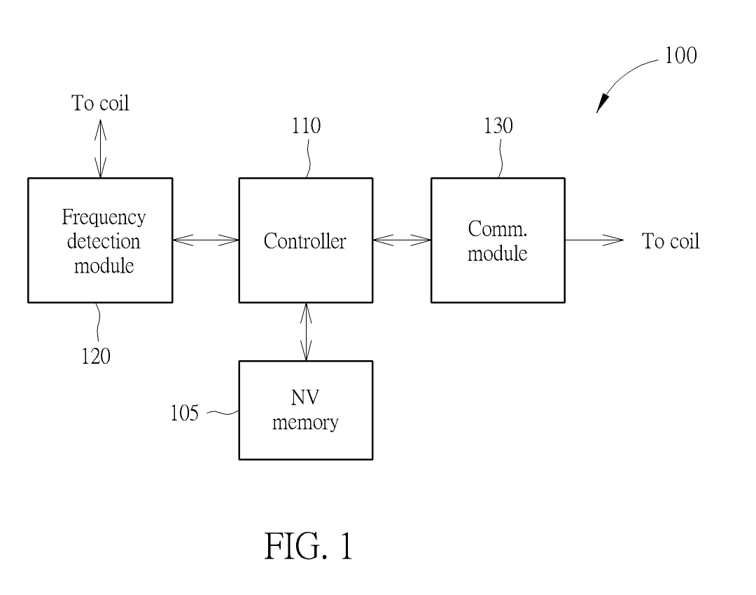

FIG. 1 illustrates a diagram of an apparatus 100 for performing wireless charging control of an electronic device according to a first embodiment of the present invention, where the apparatus 100 may comprise at least one portion (e.g. a portion or all) of the electronic device. For example, the apparatus 100 may comprise a portion of the electronic device mentioned above, and more particularly, can be at least one hardware circuit such as at least one integrated circuit (IC) within the electronic device and associated circuits thereof. In another example, the apparatus 100 can be the whole of the electronic device mentioned above. In another example, the apparatus 100 may comprise a system comprising the electronic device mentioned above (e.g. a wireless power transfer system comprising the electronic device). Examples of the electronic device may include, but not limited to, a mobile phone (e.g. a multifunctional mobile phone), a personal digital assistant (PDA), and a personal computer such as a laptop computer.

As shown in FIG. 1, the apparatus 100 may comprise a non-volatile (NV) memory 105 (e.g. an electrically erasable programmable read only memory (EEPROM), or a Flash memory), a controller 110 (e.g. a microprocessor), a frequency detection module 120, and a communications module 130 (labeled “Comm. module” in FIG. 1, for brevity), where each of the frequency detection module 120 and the communications module 130 is coupled to a power input coil of the electronic device (labeled “To coil” in FIG. 1, for brevity), and the controller 110 is coupled to the NV memory 105, the frequency detection module 120, and the communications module 130. According to this embodiment, the NV memory 105 is arranged to store information for the electronic device, such as predetermined information regarding wireless charging, and the controller 110 is arranged to perform wireless charging control. In addition, the detection module 120 is arranged to perform some detection operations for the controller 110, and more particularly, to perform frequency detection operations according to one or more induced signals of the power input coil of the electronic device. Additionally, the communications module 130 is arranged to wirelessly communicate with an external device (which is positioned outside the electronic device) for the controller 110 by utilizing the power input coil (not shown in FIG. 1) of the electronic device.

According to this embodiment, the controller 110 is arranged for determining a set of program codes within multiple sets of program codes to be an active set of program codes, and loading this set of program codes from the NV memory 105, to control wireless charging operations of the electronic device. As a result of running the active set of program codes, the controller 110 may perform input power estimation in a situation where the electronic device is charged wirelessly, and more particularly, to generate accurate information regarding the power that is received through wireless charging, and to perform wireless charging foreign object detection (FOD). Regarding implementation details of the wireless charging FOD mentioned above, please refer to, for example, the Wireless Power Consortium (WPC) Qi V1.1 standard for more information.

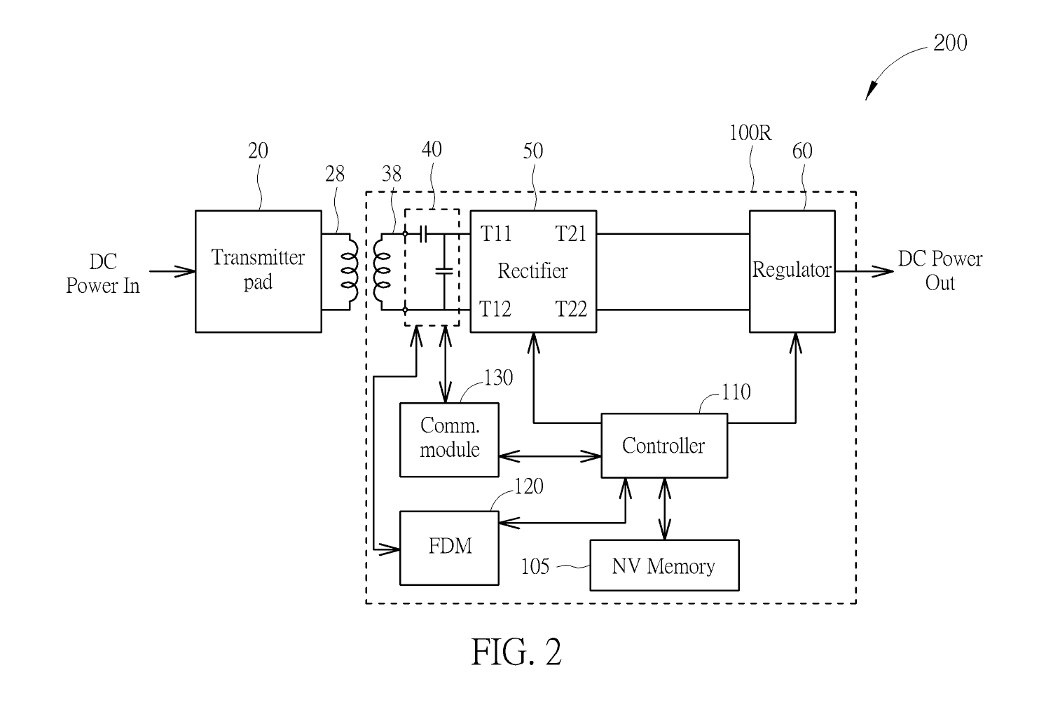

FIG. 2 is a diagram of a wireless power transfer system 200 according to an embodiment of the present invention, where the apparatus 100 may comprise at least one portion (e.g. a portion or all) of the wireless power transfer system 200. For example, the apparatus 100 may comprise a portion of the wireless power transfer system 200, and more particularly, can be a wireless charging receiver 100R (which can also be referred to as the receiver, for brevity) within the electronic device mentioned above, which means the apparatus 100 may comprise all components within the wireless charging receiver 100R shown in FIG. 2. In another example, the apparatus 100 may comprise a portion of the wireless power transfer system 200, and more particularly, can be the whole of the electronic device mentioned above, which means the apparatus 100 may comprise all components within the electronic device. In another example, the apparatus 100 can be the whole of the wireless power transfer system 200.

As shown in FIG. 2, in addition to the wireless charging receiver 100R, the wireless power transfer system 200 may further comprise a transmitter pad 20 equipped with a power output coil 28. For better comprehension, the power output coil 28 can be illustrated outside the transmitter pad 20. This is for illustrative purposes only, and is not meant to be a limitation of the present invention. According to some variations of this embodiment, the power output coil 28 can be integrated into the transmitter pad 20. According to this embodiment, in addition to the NV memory 105, the controller 110, the frequency detection module 120 (labeled “FDM” in FIG. 2, for brevity), and the communications module 130 mentioned above, the wireless charging receiver 100R may further comprise a power input coil 38, a matching circuit 40, a rectifier 50, and a regulator 60. In some examples, the regulator 60 mentioned above can be a buck regulator. This is for illustrative purposes only, and is not meant to be a limitation of the present invention. Please note that the implementation of the regulator 60 mentioned above may vary when needed. More particularly, in some other examples, the regulator 60 mentioned above can be a low dropout (LDO) regulator.

In addition, the regulator 60 is coupled to the direct current (DC) output terminal T21 of the rectifier 50 of the electronic device, and the two alternating current (AC) input terminals T11 and T12 of the rectifier 50 are coupled to the two terminals of the power input coil 38 of the electronic device. In this embodiment, the terminal T22 of the rectifier 50 can be regarded as a ground terminal, and the two terminals T21 and T22 can be utilized for coupling the next stage such as the regulator 60. More particularly, the rectifier 50 may obtain an AC input from the power input coil 38 through the two AC input terminals T11 and T12 of the rectifier 50, and rectifies the AC input to provide a DC output at the DC output terminal T21, such as a DC voltage level with respect to a ground voltage level at the terminal T22 (i.e. the ground terminal). For example, the AC input can be obtained from the power input coil 38 when the electronic device is wirelessly charged through the power input coil 38 by the transmitter pad 20. In practice, the matching circuit 40 may comprise some impedance components such as some capacitors. This is for illustrative purposes only, and is not meant to be a limitation of the present invention.

Based on the architecture shown in FIG. 2, electric power may be transferred from the left side (e.g. the input labeled “DC Power In” in the leftmost of FIG. 2) to the right side (e.g. the input labeled “DC Power Out” in the rightmost of FIG. 2) stage by stage, where power loss may occur in some of the stages. In a situation where a foreign object, such as a metallic objects or magnetic object, occasionally drops nearby and starts absorbing energy from the transmitter pad 20 of this embodiment, the controller 110 can accurately estimate the received power of the power input coil 38 and send a received power report corresponding to the received power (e.g. a received power packet corresponding to the estimated value of the received power) to the transmitter pad 20 through related components (e.g. the communications module 130, the matching circuit 40, the power input coil 38, and the power output coil 28) for performing wireless charging FOD. As a result, the transmitter pad 20 may stop outputting power toward the electronic device right away. This is for illustrative purposes only, and is not meant to be a limitation of the present invention.

According to this embodiment, the regulator 60 can be utilized as the next stage of the rectifier 50. This is for illustrative purposes only, and is not meant to be a limitation of the present invention. According to some variations of this embodiment, the regulator 60 can be omitted, and some circuits of the electronic device mentioned above may directly utilize the aforementioned DC output such as the DC voltage level mentioned above.

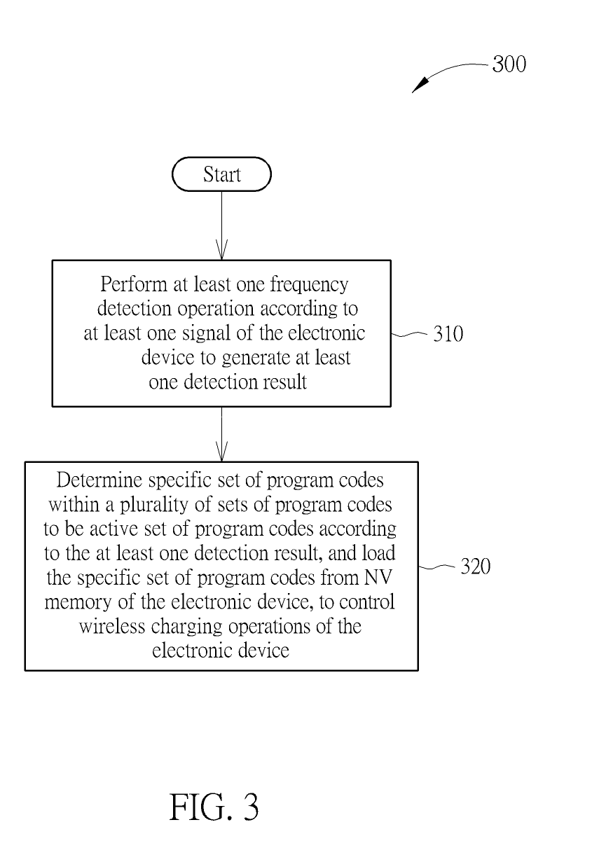

FIG. 3 illustrates a flowchart of a method 300 for performing wireless charging control of an electronic device according to an embodiment of the present invention. The method 300 shown in FIG. 3 can be applied to the apparatus 100 shown in FIG. 1 (more particularly, the wireless power transfer system 200 of the embodiment shown in FIG. 2), and can be applied to the controller 110 thereof. The method can be described as follows.

In Step 310, the frequency detection module 120 performs at least one frequency detection operation (e.g. one or more frequency detection operations) according to at least one signal (e.g. one or more signals) of the electronic device to generate at least one detection result. For example, the aforementioned at least one signal of the electronic device may comprise at least one induced signal (e.g. one or more induced signals) of a power input coil of the electronic device, such as the power input coil mentioned in the embodiment shown in FIG. 1 or the power input coil 38 shown in FIG. 2.

More particularly, in Step 310, the frequency detection module 120 may perform the aforementioned at least one frequency detection operation (e.g. one or more frequency detection operations) according to the aforementioned at least one induced signal of the power input coil of the electronic device, such as the power input coil mentioned in the embodiment shown in FIG. 1 or the power input coil 38 shown in FIG. 2, to generate the aforementioned at least one detection result (e.g. one or more detection results). For example, the aforementioned at least one signal of the electronic device, such as the induced signal (s) of the power input coil 38, can be directly (or indirectly) obtained from the power input coil 38, where the frequency detection module 120 may perform the aforementioned at least one frequency detection operation (e.g. one or more frequency detection operations) on the power input coil 38. This is for illustrative purposes only, and is not meant to be a limitation of the present invention. Please note that, in some examples, the aforementioned at least one signal of the electronic device may comprise at least one induced signal (e.g. one or more induced signals) of a power input coil of the electronic device, such as the power input coil mentioned in the embodiment shown in FIG. 1 or the power input coil 38 shown in FIG. 2, or at least one derivative (e.g. one or more derivatives) of the aforementioned at least one induced signal.

Thus, in these examples, in Step 310, the frequency detection module 120 may perform the aforementioned at least one frequency detection operation (e.g. one or more frequency detection operations) according to the aforementioned at least one induced signal of the power input coil of the electronic device or according to the aforementioned at least one derivative (e.g. one or more derivatives) of the aforementioned at least one induced signal of the power input coil of the electronic device, to generate the aforementioned at least one detection result (e.g. one or more detection results). For example, a rectifier of the electronic device, such as the rectifier 50 shown in FIG. 2, can be coupled to the power input coil 38 through a matching circuit of the electronic device, such as the matching circuit 40 shown in FIG. 2, where the aforementioned at least one signal of the electronic device, such as the induced signal(s) of the power input coil 38 or at least one derivative (e.g. one or more derivatives) of the induced signal(s) of the power input coil 38, can be obtained from two terminals between the matching circuit 40 and the rectifier 50, and more particularly, the two AC input terminals T11 and T12 of the rectifier 50. This is for illustrative purposes only, and is not meant to be a limitation of the present invention.

In Step 320, the controller 110 determines a specific set of program codes within a plurality of sets of program codes to be an active set of program codes such as that mentioned above according to the aforementioned at least one detection result, and loads the specific set of program codes from the NV memory 105 of the electronic device, to control wireless charging operations of the electronic device.

Based on the method 300 shown in FIG. 3, as a result of selecting a proper set of program codes from the plurality of sets of program codes, such as the specific set of program codes, the controller 110 is capable of loading the proper set of program codes (e.g. the specific set of program codes) from the NV memory 105 of the electronic device. As the proper set of program codes (e.g. the specific set of program codes) can be correctly selected and loaded from the NV memory 105 of the electronic device, the controller 110 is capable of correctly controlling wireless charging operations of the electronic device.

As mentioned above, the aforementioned at least one signal of the electronic device, such as the induced signal(s) of the power input coil 38 or the aforementioned at least one derivative (e.g. one or more derivatives) of the induced signal(s) of the power input coil 38, can be obtained from the two terminals between the matching circuit 40 and the rectifier 50, and more particularly, the two AC input terminals T11 and T12 of the rectifier 50. Thus, the frequency detection module 120 may perform the aforementioned at least one frequency detection operation (e.g. one or more frequency detection operations) on the two AC input terminals T11 and T12 of the rectifier 50. This is for illustrative purposes only, and is not meant to be a limitation of the present invention. In some examples, the aforementioned at least one signal of the electronic device, such as the induced signal(s) of the power input coil 38 or the aforementioned at least one derivative (e.g. one or more derivatives) of the induced signal(s) of the power input coil 38, can be obtained from the matching circuit of the electronic device mentioned above, such as the matching circuit 40 shown in FIG. 2, where the frequency detection module 120 may perform the aforementioned at least one frequency detection operation (e.g. one or more frequency detection operations) on the matching circuit of the electronic device mentioned above, such as the matching circuit 40 shown in FIG. 2.

As mentioned above, in Step 310, the frequency detection module 120 may perform the aforementioned at least one frequency detection operation (e.g. one or more frequency detection operations) according to the aforementioned at least one induced signal of the power input coil of the electronic device (such as the power input coil mentioned in the embodiment shown in FIG. 1 or the power input coil 38 shown in FIG. 2) or according to the aforementioned at least one derivative (e.g. one or more derivatives) of the aforementioned at least one induced signal of the power input coil of the electronic device, to generate the aforementioned at least one detection result (e.g. one or more detection results). This is for illustrative purposes only, and is not meant to be a limitation of the present invention. Please note that, in some embodiments, the aforementioned at least one signal of the electronic device may comprise at least one induced signal (e.g. one or more induced signals) of a power input coil of the electronic device, such as the power input coil mentioned in the embodiment shown in FIG. 1 or the power input coil 38 shown in FIG. 2, or at least one derivative (e.g. one or more derivatives) of the aforementioned at least one induced signal, and/or at least one timing signal (e.g. one or more timing signals) of a specific stage within at least one stage (e.g. one or more stages) coupled to the power input coil mentioned above.

According to some of these embodiments, in Step 310, the frequency detection module 120 may perform the aforementioned at least one frequency detection operation (e.g. one or more frequency detection operations) according to the aforementioned at least one signal of the electronic device, such as the aforementioned at least one timing signal of the specific stage within the aforementioned at least one stage (e.g. one or more stages) coupled to the power input coil of the electronic device, to generate the aforementioned at least one detection result. For example, in Step 310, the frequency detection module 120 may perform the aforementioned at least one frequency detection operation (e.g. one or more frequency detection operations) according to the aforementioned at least one timing signal of the specific stage mentioned above, such as at least one timing signal (e.g. one or more timing signals) of the rectifier 50. More particularly, the aforementioned at least one timing signal of the rectifier 50 may comprise one or more internal timing signals of the rectifier 50. For example, in a situation where the rectifier 50 is a synchronous rectifier, the aforementioned one or more internal timing signals of the rectifier 50 can be one or more synchronous rectifier gate control signals (such as one or more gate control signals within the synchronous rectifier mentioned above).

According to some embodiments, the frequency detection module 120 may perform a filtering operation on the aforementioned at least one signal of the electronic device, such as the aforementioned at least one induced signal of the power input coil, to obtain a filtered signal. In addition, the frequency detection module 120 may perform the aforementioned at least one frequency detection operation on the filtered signal to determine a frequency of the filtered signal. More particularly, the frequency of the filtered signal may indicate a specific frequency of wireless signals received by the power input coil 38.

According to some embodiments, the controller 110 may automatically select the specific set of program codes from the plurality of sets of program codes as the active set of program codes according to a predetermined relationship between the specific set of program codes and the at least one detection result. More particularly, the controller 110 may obtain the predetermined relationship between the specific set of program codes and the aforementioned at least one detection result from a look up table (LUT) within the electronic device. This is for illustrative purposes only, and is not meant to be a limitation of the present invention. According to some embodiments, the controller 110 may select the specific set of program codes from the plurality of sets of program codes as the active set of program codes according to a user input. More particularly, when failure of determining the specific set of program codes within the plurality of sets of program codes to be the active set of program codes according to the aforementioned at least one detection result is detected, the controller 110 may select the specific set of program codes from the plurality of sets of program codes as the active set of program codes according to the user input.

According to some embodiments, the controller 110 may select one set of program codes, such as another set of program codes that is different from the specific set of program codes, from the plurality of sets of program codes as the active set of program codes according to a user input. More particularly, when failure of determining the specific set of program codes within the plurality of sets of program codes to be the active set of program codes according to the aforementioned at least one detection result is detected, the controller 110 may select this set of program codes (e.g. the aforementioned one set of program codes) from the plurality of sets of program codes as the active set of program codes according to the user input. This is for illustrative purposes only, and is not meant to be a limitation of the present invention.

According to some embodiments, the controller 110 may select at least one candidate set of program codes from the plurality of sets of program codes according to the aforementioned at least one detection result. In addition, the controller may control the electronic device to notify the user of the electronic device of the aforementioned at least one candidate set of program codes, to allow the user to choose the active set of program codes. Additionally, the controller 110 may select the specific set of program codes from the aforementioned at least one candidate set of program codes as the active set of program codes according to a user input. This is for illustrative purposes only, and is not meant to be a limitation of the present invention. According to some embodiments, the controller 110 may select at least one suggested set of program codes from the plurality of sets of program codes according to the at least one detection result. In addition, the controller may control the electronic device to notify the user of the electronic device of the aforementioned at least one suggested set of program codes, to allow the user to choose the active set of program codes. Additionally, the controller 110 may select the specific set of program codes from the plurality of sets of program codes as the active set of program codes according to a user input.

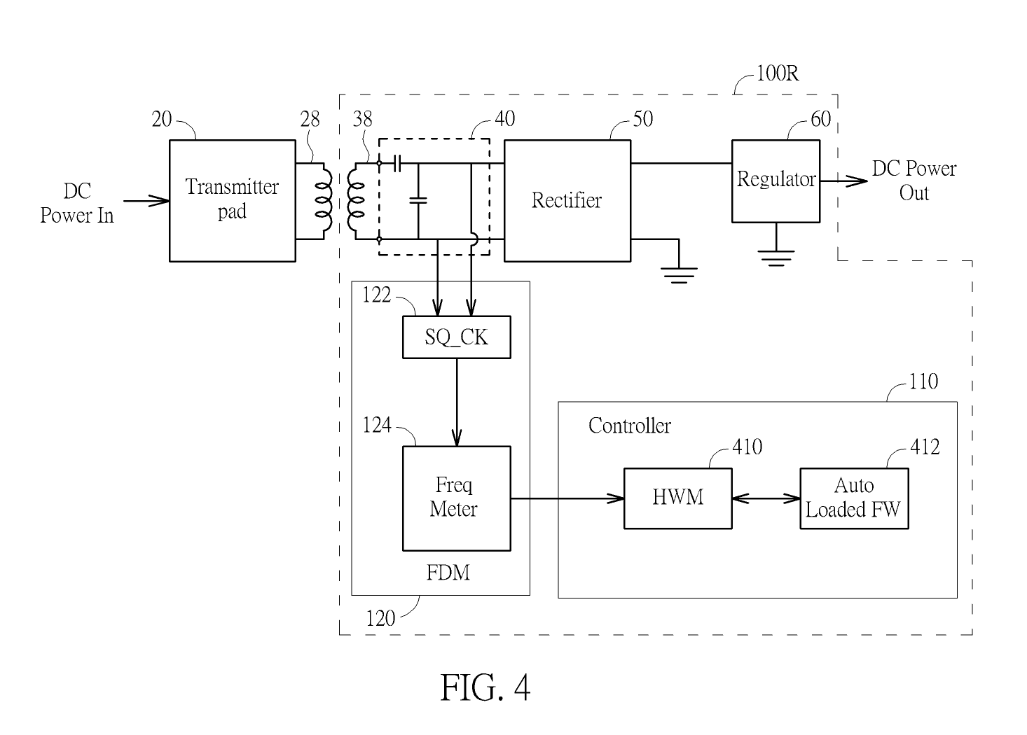

FIG. 4 illustrates a control scheme involved with the method shown in FIG. 3 according to an embodiment of the present invention. As shown in FIG. 4, the controller 110 of this embodiment may comprise a hardware control module 410 (labeled “HWM” in FIG. 4, for brevity). In addition, the frequency detection module 120 (labeled “FDM” in FIG. 4, for brevity) of this embodiment may comprise a filtering module 122 such as a sequence clock filter (labeled “SQ_CK” in FIG. 4, for brevity), where the filtering module 122 can be arranged for performing the filtering operation mentioned above on the induced signal(s) of the power input coil 38 to obtain the aforementioned filtered signal such as a sequence clock. Additionally, the frequency detection module 120 of this embodiment may further comprise a frequency meter 124 (labeled “Freq Meter” in FIG. 4, for brevity), where the frequency meter 124 can be arranged for performing the aforementioned at least one frequency detection operation on the filtered signal to determine the aforementioned frequency of the filtered signal.

According to this embodiment, the controller 110 may utilize the hardware control module 410 to automatically select the specific set of program codes from the plurality of sets of program codes as the active set of program codes according to the predetermined relationship between the specific set of program codes and the aforementioned at least one detection result. More particularly, the controller 110 may obtain the predetermined relationship between the specific set of program codes and the aforementioned at least one detection result from a LUT within the electronic device, such as the LUT mentioned above. As a result, the controller 110 may automatically load the specific set of program codes such as a set of firmware (FW) codes 412 (labeled “Auto Loaded FW” in FIG. 4, for better comprehension) from the NV memory 105 of the electronic device, to control wireless charging operations of the electronic device.

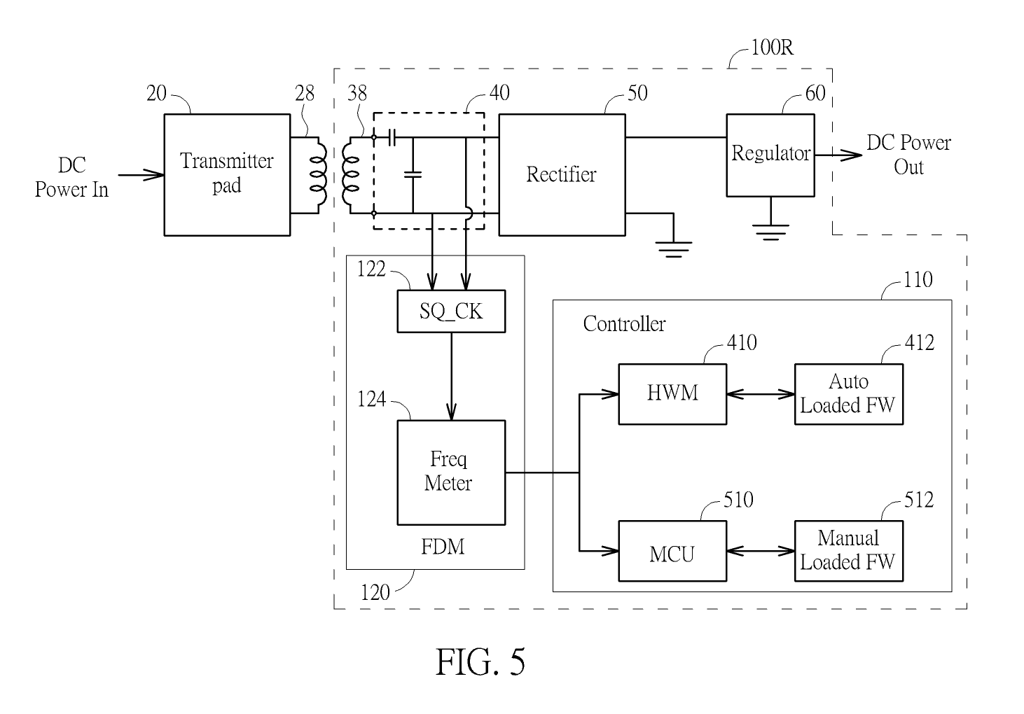

FIG. 5 illustrates a control scheme involved with the method shown in FIG. 3 according to another embodiment of the present invention. As shown in FIG. 5, the controller 110 of this embodiment may comprise the aforementioned hardware control module 410 (labeled “HWM” in FIG. 5, for brevity) and a micro control unit (MCU) 510. In addition, the frequency detection module 120 (labeled “FDM” in FIG. 4, for brevity) of this embodiment may comprise the filtering module 122 and the frequency meter 124 that are described in the embodiment shown in FIG. 4.

According to this embodiment, the controller 110 may utilize the hardware control module 410 to automatically select the specific set of program codes from the plurality of sets of program codes as the active set of program codes according to the predetermined relationship between the specific set of program codes and the aforementioned at least one detection result. More particularly, the controller 110 may obtain the predetermined relationship between the specific set of program codes and the aforementioned at least one detection result from a LUT such as that mentioned above. As a result, the controller 110 may automatically load the specific set of program codes such as a set of firmware (FW) codes 412 (labeled “Auto Loaded FW” in FIG. 5, for better comprehension) from the NV memory 105 of the electronic device, to control wireless charging operations of the electronic device. This is for illustrative purposes only, and is not meant to be a limitation of the present invention. Please note that the controller 110 of this embodiment can be equipped with another control path. For example, the controller 110 may select one set of program codes (e.g. the specific set of program codes, or another set of program codes that is different from the specific set of program codes) from the plurality of sets of program codes as the active set of program codes according to a user input. More particularly, when failure of determining the specific set of program codes within the plurality of sets of program codes to be the active set of program codes according to the aforementioned at least one detection result is detected, the controller 110 may select this set of program codes (e.g. the specific set of program codes, or the other set of program codes that is different from the specific set of program codes) from the plurality of sets of program codes as the active set of program codes according to the user input.

As a result, no matter which control path of the two control paths within the controller 110 is utilized, the controller 110 may automatically load the specific set of program codes such as the set of firmware (FW) codes 412 (labeled “Auto Loaded FW” in FIG. 5, for better comprehension), or semi-automatically load the aforementioned one set of program codes (e.g. the specific set of program codes, or the other set of program codes that is different from the specific set of program codes) such as a set of firmware (FW) codes 512 (labeled “Manual Loaded FW” in FIG. 5, for better comprehension), from the NV memory 105 of the electronic device, to control wireless charging operations of the electronic device.

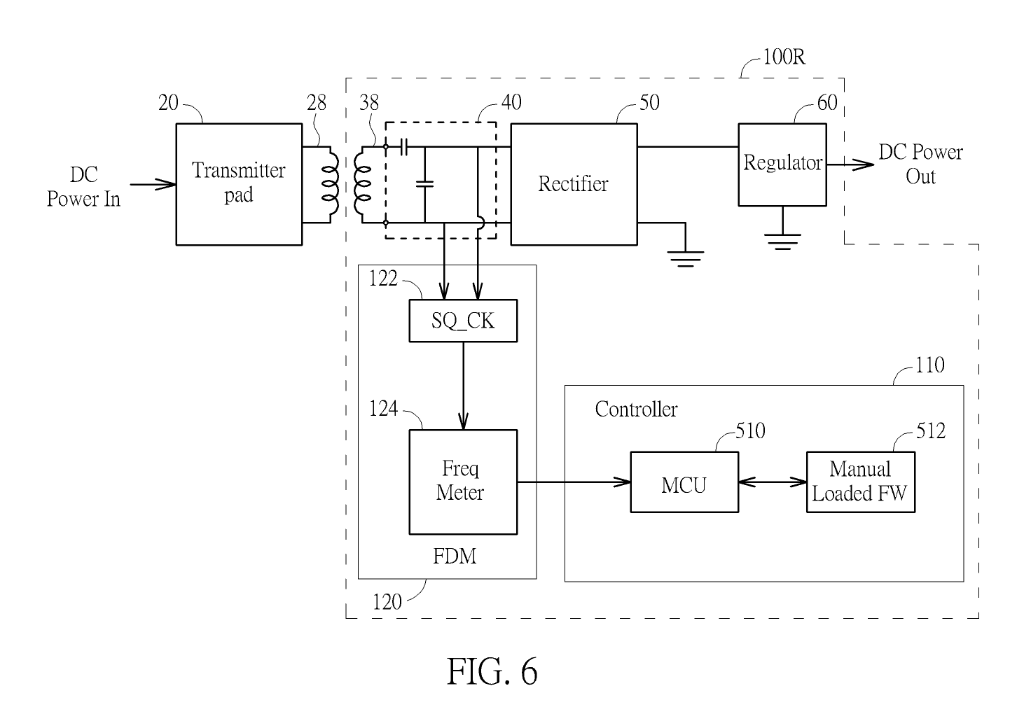

FIG. 6 illustrates a control scheme involved with the method shown in FIG. 3 according to another embodiment of the present invention. As shown in FIG. 6, the controller 110 of this embodiment may comprise the aforementioned MCU 510. In addition, the frequency detection module 120 (labeled “FDM” in FIG. 4, for brevity) of this embodiment may comprise the filtering module 122 and the frequency meter 124 that are described in the embodiment shown in FIG. 4.

According to this embodiment, the controller 110 may select at least one candidate set of program codes from the plurality of sets of program codes according to the aforementioned at least one detection result. In addition, the controller 110 may control the electronic device to notify the user (i.e. the user of the electronic device) of the aforementioned at least one candidate set of program codes, to allow the user to choose the active set of program codes. Additionally, the controller 110 may select the specific set of program codes from the aforementioned at least one candidate set of program codes as the active set of program codes according to a user input.

As a result, the controller 110 may semi-automatically load one set of program codes (more particularly, the specific set of program codes in this embodiment) such as the set of firmware (FW) codes 512 (labeled “Manual Loaded FW” in FIG. 6, for better comprehension), from the NV memory 105 of the electronic device, to control wireless charging operations of the electronic device. This is for illustrative purposes only, and is not meant to be a limitation of the present invention. According to some variations of this embodiment, the controller 110 may semi-automatically load one set of program codes (e.g. another set of program codes that is different from the specific set of program codes) such as the set of firmware (FW) codes 512 (labeled “Manual Loaded FW” in FIG. 6, for better comprehension), from the NV memory 105 of the electronic device, to control wireless charging operations of the electronic device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing wireless charging control of an electronic device, the method comprising the steps of:
performing at least one frequency detection operation according to at least one signal of the electronic device to generate at least one detection result; and
determining a specific set of program codes within a plurality of sets of program codes to be an active set of program codes according to the at least one detection result, and loading the specific set of program codes from a non-volatile (NV) memory of the electronic device, to control wireless charging operations of the electronic device.

2. The method of claim 1, wherein the at least one signal of the electronic device comprises at least one induced signal of a power input coil of the electronic device or at least one derivative of the at least one induced signal; a rectifier of the electronic device is coupled to the power input coil through a matching circuit of the electronic device; and the at least one signal of the electronic device is obtained from two terminals between the matching circuit and the rectifier.

3. The method of claim 2, wherein the two terminals between the matching circuit and the rectifier are two alternating current (AC) input terminals of the rectifier.

4. The method of claim 1, wherein the step of performing the at least one frequency detection operation according to the at least one signal of the electronic device to generate the at least one detection result further comprises:
performing a filtering operation on the at least one signal of the electronic device to obtain a filtered signal; and
performing the at least one frequency detection operation on the filtered signal to determine a frequency of the filtered signal.

5. The method of claim 4, wherein the frequency of the filtered signal indicates a specific frequency of wireless signals received by the power input coil.

6. The method of claim 1, wherein the step of determining the specific set of program codes within the plurality of sets of program codes to be the active set of program codes according to the at least one detection result further comprises:
automatically selecting the specific set of program codes from the plurality of sets of program codes as the active set of program codes according to a predetermined relationship between the specific set of program codes and the at least one detection result.

7. The method of claim 6, wherein the step of determining the specific set of program codes within the plurality of sets of program codes to be the active set of program codes according to the at least one detection result further comprises:
obtaining the predetermined relationship between the specific set of program codes and the at least one detection result from a look up table (LUT) within the electronic device.

8. The method of claim 1, further comprising:
selecting one set of program codes from the plurality of sets of program codes as the active set of program codes according to a user input.

9. The method of claim 8, wherein the step of selecting the specific set of program codes from the plurality of sets of program codes as the active set of program codes according to the user input further comprises:
when failure of determining the specific set of program codes within the plurality of sets of program codes to be the active set of program codes according to the at least one detection result is detected, selecting the one set of program codes from the plurality of sets of program codes as the active set of program codes according to the user input.

10. The method of claim 1, wherein the step of determining the specific set of program codes within the plurality of sets of program codes to be the active set of program codes according to the at least one detection result further comprises:
selecting at least one candidate set of program codes from the plurality of sets of program codes according to the at least one detection result;
controlling the electronic device to notify a user, the user of the electronic device, of the at least one candidate set of program codes, to allow the user to choose the active set of program codes; and
selecting the specific set of program codes from the at least one candidate set of program codes as the active set of program codes according to a user input.

11. The method of claim 1, wherein the at least one signal of the electronic device comprises at least one induced signal of a power input coil of the electronic device or at least one derivative of the at least one induced signal, or at least one timing signal of a specific stage within at least one stage coupled to the power input coil.

12. An apparatus for performing wireless charging control of an electronic device, the apparatus comprising at least one portion of the electronic device, the apparatus comprising:
a non-volatile (NV) memory, arranged for storing information for the electronic device;
a frequency detection module, coupled to a power input coil of the electronic device, arranged for performing at least one frequency detection operation according to at least one signal of the electronic device to generate at least one detection result; and
a controller, coupled to the NV memory and the frequency detection module, arranged for determining a specific set of program codes within a plurality of sets of program codes to be an active set of program codes according to the at least one detection result, and loading the specific set of program codes from the NV memory, to control wireless charging operations of the electronic device.

13. The apparatus of claim 12, wherein the at least one signal of the electronic device comprises at least one induced signal of a power input coil of the electronic device or at least one derivative of the at least one induced signal; a rectifier of the electronic device is coupled to the power input coil through a matching circuit of the electronic device; and the at least one signal of the electronic device is obtained from two terminals between the matching circuit and the rectifier.

14. The apparatus of claim 13, wherein the two terminals between the matching circuit and the rectifier are two alternating current (AC) input terminals of the rectifier.

15. The apparatus of claim 12, wherein the frequency detection module is arranged for performing a filtering operation on the at least one signal of the electronic device to obtain a filtered signal; and the frequency detection module is arranged for performing the at least one frequency detection operation on the filtered signal to determine a frequency of the filtered signal.

16. The apparatus of claim 15, wherein the frequency of the filtered signal indicates a specific frequency of wireless signals received by the power input coil.

17. The apparatus of claim 12, wherein the controller is arranged for automatically selecting the specific set of program codes from the plurality of sets of program codes as the active set of program codes according to a predetermined relationship between the specific set of program codes and the at least one detection result.

18. The apparatus of claim 17, wherein the controller is arranged for obtaining the predetermined relationship between the specific set of program codes and the at least one detection result from a look up table (LUT) within the electronic device.

19. The apparatus of claim 12, wherein the controller is further arranged for selecting one set of program codes from the plurality of sets of program codes as the active set of program codes according to a user input.

20. The apparatus of claim 19, wherein when failure of determining the specific set of program codes within the plurality of sets of program codes to be the active set of program codes according to the at least one detection result is detected, the controller selects the one set of program codes from the plurality of sets of program codes as the active set of program codes according to the user input.

21. The apparatus of claim 12, wherein the controller is arranged for selecting at least one candidate set of program codes from the plurality of sets of program codes according to the at least one detection result; the controller is arranged for controlling the electronic device to notify a user, the user of the electronic device, of the at least one candidate set of program codes, to allow the user to choose the active set of program codes; and the controller is arranged for selecting the specific set of program codes from the at least one candidate set of program codes as the active set of program codes according to a user input.

22. The apparatus of claim 12, wherein the at least one signal of the electronic device comprises at least one induced signal of a power input coil of the electronic device or at least one derivative of the at least one induced signal, or at least one timing signal of a specific stage within at least one stage coupled to the power input coil.
